(19) United States
(12) Patent Application Publication
(10) Pub. No.: US 2021/0055933 A1
(43) Pub. Date: Feb. 25, 2021

(54) COMPLIANCE POLICY MANAGEMENT AND SCHEDULING

(71) Applicant: International Business Machines Corporation, Armonk, NY (US)

(72) Inventors: Muhammed Fatih Bulut, Ossining, NY (US); Constantin Mircea Adam, Fairfield, CT (US); Milton H. Hernandez, Tenafly, NJ (US); Maja Vukovic, New York, NY (US)

(21) Appl. No.: 16/546,775

(22) Filed: Aug. 21, 2019

(51) Int. Cl. G06F 9/38; G06F 9/48; G06N 20/00

(52) U.S. Cl. CPC G06F 9/3838; G06N 20/00; G06F 9/4881

(57) ABSTRACT

Systems, computer-implemented methods, and computer program products that can facilitate compliance policy management and scheduling are provided. According to an embodiment, a system can comprise a memory that stores computer executable components and a processor that executes the computer executable components stored in the memory. The computer executable components can comprise a policy analyzer component that identifies one or more dependency relationships between a first compliance policy and one or more second compliance policies. The computer executable components can further comprise a scheduler component that generates a policy execution plan based on the one or more dependency relationships.

### BACKGROUND

The subject disclosure relates to compliance policy management and scheduling, and more specifically, to determining compliance policy dependencies and scheduling execution of compliance policies based the dependencies.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that can facilitate compliance policy management and scheduling are described.

According to an embodiment, a system can comprise a memory that stores computer executable components and a processor that executes the computer executable components stored in the memory. The computer executable components can comprise a policy analyzer component that identifies one or more dependency relationships between a first compliance policy and one or more second compliance policies. The computer executable components can further comprise a scheduler component that generates a policy execution plan based on the one or more dependency relationships.

According to another embodiment, a computer-implemented method can comprise identifying, by a system operatively coupled to a processor, one or more dependency relationships between a first compliance policy and one or more second compliance policies. The computer-implemented method can further comprise generating, by the system, a policy execution plan based on the one or more dependency relationships.

According to another embodiment, a computer program product facilitating computational creativity is provided. The computer program product comprising a computer readable storage medium having program instructions embodied therewith, the program instructions executable by a processor to cause the processor to identify, by the processor, one or more dependency relationships between a first compliance policy and one or more second compliance policies. The program instructions are further executable by the processor to cause the processor to generate, by the processor, a policy execution plan based on the one or more dependency relationships.

### DESCRIPTION OF THE DRAWINGS

FIG. 1 illustrates a block diagram of an example, non-limiting system that can facilitate compliance policy management and scheduling in accordance with one or more embodiments described herein.

FIG. 2 illustrates a block diagram of an example, non-limiting system that can facilitate compliance policy management and scheduling in accordance with one or more embodiments described herein.

FIG. 3 illustrates a diagram of an example, non-limiting system that can facilitate compliance policy management and scheduling in accordance with one or more embodiments described herein.

FIG. 4 illustrates a diagram of an example, non-limiting system that can facilitate compliance policy management and scheduling in accordance with one or more embodiments described herein.

FIG. 5 illustrates a diagram of an example, non-limiting system that can facilitate compliance policy management and scheduling in accordance with one or more embodiments described herein.

FIGS. 6A, 6B, 6C, and 6D illustrate diagrams of example, non-limiting systems that can facilitate compliance policy management and scheduling in accordance with one or more embodiments described herein.

FIG. 7 illustrates a flow diagram of an example, non-limiting computer-implemented method that can facilitate computational creativity in accordance with one or more embodiments described herein.

FIG. 8 illustrates a block diagram of an example, non-limiting operating environment in which one or more embodiments described herein can be facilitated.

FIG. 9 illustrates a block diagram of an example, non-limiting cloud computing environment in accordance with one or more embodiments of the subject disclosure.

FIG. 10 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given a set of compliance policies (e.g., policy_linux_file_permissions, policy_linux_pass_max_age, policy_linux_pass_min_age, etc.) for different platforms (e.g., Advanced Interactive eXecutive (AIX), Linux, Windows, etc.) some compliance policies depend on one or more other compliance policies. For example, given compliance policy P₁—policy_linux_oracle_pass_max_age (set non-expiring password for an application; oracle database user) and compliance policy P₂—policy_linux_pass_max_age (set expiring password in operating system (OS) level), compliance policy P₂ can depend on compliance policy P₁ (e.g., dependency: P₁→P₂). Execution of multiple compliance policies in synchronous order is time consuming. If dependencies between multiple compliance policies are known, execution of such policies can be performed asynchronously.

A problem with existing compliance policy management and/or scheduling technologies is that, given a history of policy executions (P₁, P₂, . . . , Pₙ) for a specific environment (e.g., virtual machine (VM), container, etc.), such existing technologies do not discover dependencies between compliance policies (e.g., dependency D=[P₂→(P₄, P₇), P₃→(P₁, P₉), etc.]). Another problem with such existing technologies is that, once such dependencies are known, the existing compliance policy management and/or scheduling technologies do not generate a parallel execution plan to execute two or more compliance policies simultaneously based on the dependencies (e.g., execution E₁=[P₁, P₂, P₉], execution E₂=[P₄, P₇, P₂], execution E₃=[ . . . ], etc.),

Given the above problem with current compliance policy management and/or scheduling technologies not discovering dependencies between compliance policies and/or scheduling parallel execution plan(s) to execute two or more compliance policies simultaneously, the present disclosure can be implemented to produce a solution to this problem in the form of systems, computer-implemented methods, and/or computer program products that can: a) use previous history of compliance policy dependencies to train a machine learning model to determine whether a given set of policies (e.g., two policies (P₁, P₂)) are dependent on each other or not and the direction of the dependency based on features such as, for instance, text similarity (e.g., compliance policy description), code similarity codes corresponding respectively to such policies), weakness similarity (e.g., common weakness enumeration (CWE)), and/or another feature; b) given a compliance policy Pᵢ use the trained machine learning model to discover one or more potential dependent existing compliance policies and corresponding dependency direction (e.g., expressed as {(Pⱼ, 1), (Pₖ, 0)}); c) add compliance policy Pᵢ to a Directed Acyclic Graph (DAG) and repeat the process until all unknown dependencies are determined; d) schedule a compliance policy execution based on the number of parallelism (e.g. number of available central processing units (CPU)) and DAG; and/or e) use operational data (e.g., service tickets, request tickets, incidents, etc.) and expert feedback (e.g., subject matter expert (SME) feedback to update the dependencies.

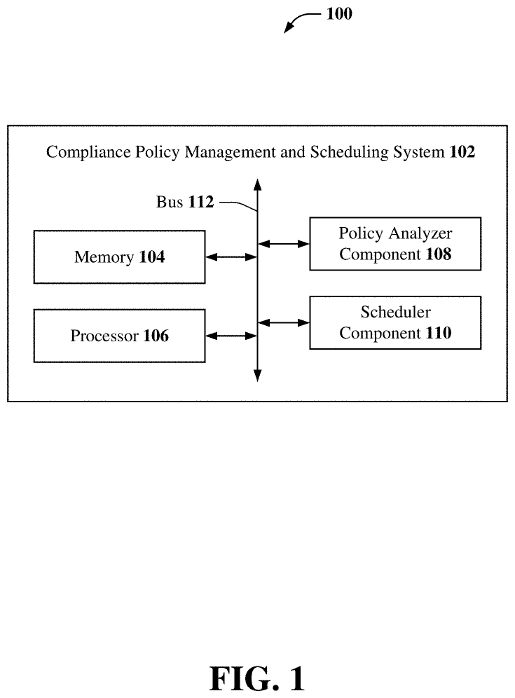

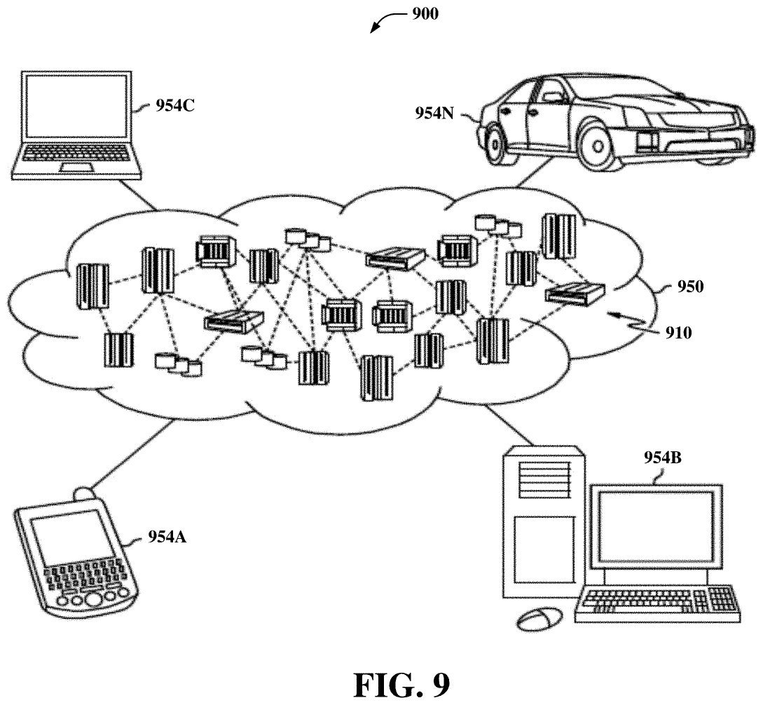

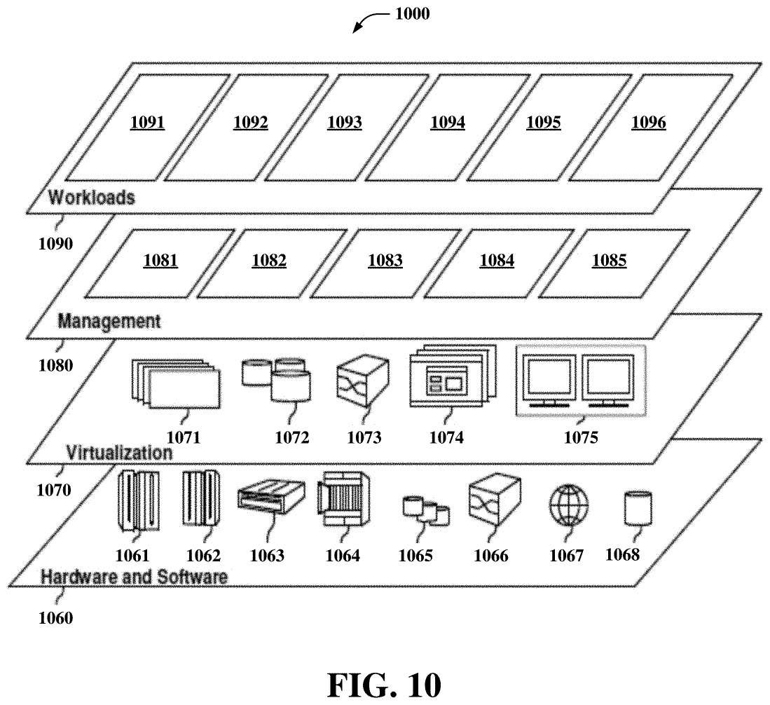

FIG. 1 illustrates a block diagram of an example, non-limiting system 100 that can facilitate compliance policy management and scheduling in accordance with one or more embodiments described herein. In some embodiments, system 100 can comprise a compliance policy management and scheduling system 102, which can be associated with a cloud computing environment. For example, compliance policy management and scheduling system 102 can be associated with cloud computing environment 950 described below with reference to FIG. 9 and/or one or more functional abstraction layers described below with reference to FIG. 10 (e.g., hardware and software layer 1060, virtualization layer 1070, management layer 1080, and/or workloads layer 1090).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned. by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Continuing now with FIG. 1, according to several embodiments, system 100 can comprise a compliance policy management and scheduling system 102. In some embodiments, compliance policy management and scheduling system 102 can comprise a memory 104, a processor 106, a policy analyzer component 108, a scheduler component 110, and/or a bus 112.

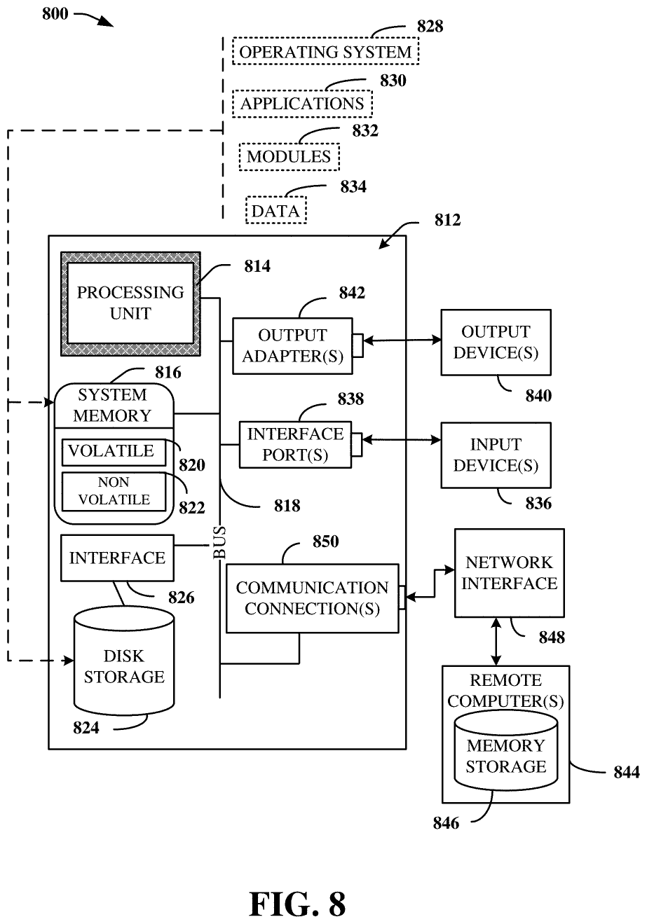

It should be appreciated that the embodiments of the subject disclosure depicted in various figures disclosed herein are for illustration only, and as such, the architecture of such embodiments are not limited to the systems, devices, and/or components depicted therein. For example, in some embodiments, system 100 and/or compliance policy management and scheduling system 102 can further comprise various computer and/or computing-based elements described herein with reference to operating environment 800 and FIG. 8. In several embodiments, such computer and/or computing-based elements can be used in connection with implementing one or more of the systems, devices, components, and/or computer-implemented operations shown and described in connection with FIG. 1 or other figures disclosed herein.

Memory 104 can store one or more computer and/or machine readable, writable, and/or executable components and/or instructions that, when executed by processor 106, can facilitate performance of operations defined by the executable components) and/or instruction(s). For example, memory 104 can store computer and/or machine readable, writable, and/or executable components and/or instructions that, when executed by processor 106, can facilitate execution of the various functions described herein relating to compliance policy management and scheduling system 102, policy analyzer component 108, scheduler component 110, and/or another component associated with compliance policy management and scheduling system 102 (e.g., trainer component 202, etc.), as described herein with or without reference to the various figures of the subject disclosure.

The memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 816 and FIG. 8. Such examples of memory 104 can be employed to implement any embodiments of the subject disclosure.

Processor 106 can comprise one or more types of processors and/or electronic circuitry that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or more central processing unit, multi-core processor, microprocessor, dual microprocessors, microcontroller, System on a Chip (SOC), array processor, vector processor, and/or another type of processor. Further examples of processor 106 are described below with reference to processing unit 814 and. FIG. 8. Such examples of processor 106 can be employed to implement any embodiments of the subject disclosure.

Compliance policy management and scheduling system 102, memory 104, processor 106, policy analyzer component 108, scheduler component 110, and/or another component of compliance policy management and scheduling system 102 as described herein can be communicatively, electrically, and/or operatively coupled to one another via a bus 112 to perform functions of system 100, compliance policy management and. scheduling system 102, and/or any components coupled therewith. In several embodiments, bus 112 can comprise one or more memory bus, memory controller, peripheral bus, external bus, local bus, and/or another type of bus that can employ various bus architectures. Further examples of bus 112 are described below with reference to system bus 818 and FIG. 8. Such examples of bus 112 can be employed to implement any embodiments of the subject disclosure.

Compliance policy management and scheduling system 102 can comprise any type of component, machine, device, facility, apparatus, and/or instrument that comprises a processor and/or can be capable of effective and/or operative communication with a wired and/or wireless network All such embodiments are envisioned. For example, compliance policy management and scheduling system 102 can comprise a server device, a computing device, a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

The compliance policy management and scheduling system 102 can be coupled (e.g., communicatively, electrically, operatively, etc.) to one or more external systems, sources, and/or devices (e.g., computing devices, communication devices, etc.) via a data cable (e.g., High-Definition Multimedia interface (HDMI), recommended standard (RS) 232, Ethernet cable, etc.). In some embodiments, compliance policy management and scheduling system 102 can be coupled (e.g., communicatively, electrically, operatively, etc.) to one or more external systems, sources, and/or devices (e.g., computing devices, communication devices, etc.) via a network.

According to multiple embodiments, such a network can comprise wired and wireless networks, including, but not limited to, a cellular network, a wide area network (WAN) (e.g., the Internet) or a local area network (LAN). For example, compliance policy management and scheduling system 102 can communicate with one or more external systems, sources, and/or devices, for instance, computing devices (and vice versa) using virtually any desired wired or wireless technology, including but not limited to: wireless fidelity (Wi-Fi), global system for mobile communications (GSM), universal mobile telecommunications system (UNITS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example, compliance policy management and scheduling system 102 can thus include hardware (e.g., a central processing unit (CPU), a transceiver, a decoder), software (e.g., a set of threads, a set of processes, software in execution) or a combination of hardware and software that facilitates communicating information between compliance policy management and scheduling system 102 and external systems, sources, and/or devices (e.g., computing devices, communication devices, etc.).

The compliance policy management and scheduling system 102 can comprise one or more computer and/or machine readable, writable, and/or executable components and/or instructions that, when executed by processor 106, can facilitate performance of operations defined by such component(s) and/or instruction(s). Further, in numerous embodiments, any component associated with compliance policy management and. scheduling system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, policy analyzer component 108, scheduler component 110, and/or any other components associated with compliance policy management and scheduling system 102 as disclosed herein (e.g., communicatively, electronically, and/or operatively coupled with and/or employed by compliance policy management and scheduling system 102), can comprise such computer and/or machine readable, writable, and/or executable component(s) and/or instruction(s). Consequently, according to numerous embodiments, compliance policy management and scheduling system 102 and/or any components associated therewith as disclosed herein, can employ processor 106 to execute such computer and/or machine readable, writable, and/or executable component(s) and/or instruction(s) to facilitate performance of one or more operations described herein with reference to compliance policy management and scheduling system 102 and/or any such components associated therewith.

The compliance policy management and scheduling system 102 can facilitate performance of operations executed by and/or associated with policy analyzer component 108, scheduler component 110, and/or another component associated with compliance policy management and scheduling system 102 as disclosed herein (e.g., trainer component 202, etc.). For example, as described in detail below, compliance policy management and scheduling system 102 can facilitate (e.g., via processor 106): identifying one or more dependency relationships between a first compliance policy and one or more second compliance policies; and/or generating a policy execution plan based on the one or more dependency relationships.

In some embodiments, compliance policy management and scheduling system 102 can further facilitate (e.g., via processor 106): training a model to identify at least one of the one or more dependency relationships or a direction of the one or more dependency relationships based on at least one of dependency data corresponding to historical compliance policies, expert feedback, or operational data feedback; identifying a direction of the one or more dependency relationships; identifying the one or more dependency relationships based on one or more similarities between the first compliance policy and one or more historical compliance policies, where the one or more similarities are selected from a group consisting of compliance policy description similarity, compliance policy code similarity, and compliance policy weakness similarity; identifying the one or more dependency relationships based on at least one of expert feedback or operational data feedback; generating a parallel policy execution plan to execute at least two compliance policies simultaneously based on the one or more dependency relationships; generating an updated directed acyclic graph based on at least one of expert feedback, operational data feedback, or the one or more dependency relationships; and/or employing the updated directed acyclic graph to generate the policy execution plan.

Policy analyzer component 108 can identify one or more dependency relationships between a first compliance policy and one or more second compliance policies. In some embodiments, policy analyzer component 108 can employ a model to identify one or more dependency relationships between a first compliance policy and one or more second compliance policies. For example, policy analyzer component 108 can employ a machine learning (ML) model based on Artificial Intelligence (AI) and Natural Language Processing (NLP), including, but not limited to, a shallow or deep neural network model, a support vector machine (SVM) model, a decision tree classifier, or any supervised or unsupervised machine learning model.

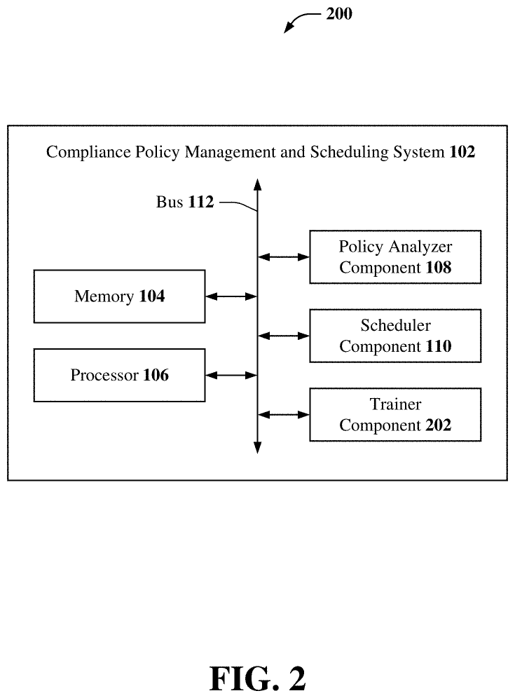

The policy analyzer component 108 can employ such a model defined above that has been trained to identify one or more dependency relationships and/or one or more corresponding dependency relationship directions (defined below) between a first compliance policy and one or more second compliance policies. For example, policy analyzer component 108 can employ such a model defined above that has been trained by, for instance, trainer component 202 as described below with reference to FIG. 2. For instance, policy analyzer component 108 can employ a support vector machine (SVM) model that has been trained by trainer component 202 (e.g., as described below with reference to FIG. 2) to identify one or more dependency relationships and/or one or more corresponding dependency relationship directions (defined below) between a first compliance policy and one or more second compliance policies.

The policy analyzer component 108 can employ such a model defined above to identify one or more dependency relationships between a first compliance policy and one or more second compliance policies, where such first compliance policy can comprise a new compliance policy corresponding to a certain environment (e.g., cloud computing, virtual machines (VM), containers, etc.) and such one or more second compliance policies can comprise one or more existing compliance policies corresponding to such a certain environment.

The policy analyzer component 108 can employ such a model defined above to identify one or more dependency relationships between a first compliance policy and one or more second compliance policies, where such one or more dependency relationships can comprise one or more correlations (e.g., associations, connections, links, etc.) between such compliance policies. For example, such one or more dependency relationships can comprise correlation(s) that can define how a first compliance policy can depend on one or more second compliance policies with respect to execution of such compliance policies. For instance, such one or more dependency relationships can comprise correlation(s) that can define how a first compliance policy can depend on one or more second compliance policies in such a manner that execution of such one or more second compliance policies must be completed before execution of such a first compliance policy can be completed. In an example, policy analyzer component 108 can employ such a model defined above to identify one or more dependency relationships between a first compliance policy and one or more second compliance policies, where such dependency relationship(s) can be defined as, for instance, dependency D=[P₂→(P₄, P₇), P₃→(P₁, P₉), etc.]). In this example, compliance policy P₂ depends on compliance policies P₄ and P₇ and/or compliance policy P₃ depends on compliance policies P₁ and P₉.

Policy analyzer component 108 can identify a direction of one or more dependency relationships between a first compliance policy and one or more second compliance policies. In some embodiments, policy analyzer component 108 can employ such a model defined above to identify a direction of one or more dependency relationships between a first compliance policy and one or more second compliance policies. For example, given a set of compliance policies P₂, P₄, and P₇, policy analyzer component 108 can identify one or more dependency relationships and/or a direction of each of such dependency relationship(s) between such policies. For instance, policy analyzer component 108, can employ such a model defined above to identify one or more dependency relationships that can be defined as, for example, dependency D=P₂→(P₄, P₇), where policy analyzer component 108 can determine that compliance policy P₂ depends on compliance policies P₄ and P₇ which can be indicative of a direction of such dependency relationships and can be denoted by the arrow (→) in the dependency definition defined here.

Policy analyzer component 108 can identify such one or more dependency relationships and/or corresponding dependency relationship direction(s) described above based on one or more similarities between a first compliance policy and one or more historical compliance policies, where such similarities can comprise compliance policy description similarity, compliance policy code similarity, and/or compliance policy weakness similarity. In some embodiments, policy analyzer component 108 can employ a model defined above to identify such one or more dependency relationships and/or corresponding dependency relationship direction(s) described above based on one or more similarities between a first compliance policy and one or more historical compliance policies. For example, policy analyzer component 108 can employ a model defined above to identify such one or more dependency relationships and/or corresponding dependency relationship direction(s) based on one or more similarities including, but not limited to, compliance policy description similarity (e.g., similarity of text in respective compliance policy descriptions), compliance policy code similarity (e.g., similarity of codes corresponding to respective compliance policies), compliance policy weakness similarity (e.g., similarity of common weakness enumeration (CWE) corresponding to respective compliance policies), and/or another similarity.

To facilitate identification of such one or more dependency relationships and/or corresponding dependency relationship direction(s) based on such one or more similarities defined above, policy analyzer component 108 can employ a model defined above and/or a natural language extraction process to identify such similarities. For example, policy analyzer component 108 can employ a model defined above and/or a natural language extraction process including, but not limited to, natural language processing (NLP), named entity recognition (NER), natural language annotation, and/or another natural language extraction process.

The policy analyzer component 108 can employ a model and/or a natural language extraction process to identify such similarities defined above based on a cosine similarity between vector representations of text extracted from, for instance, descriptions of compliance policies, codes of compliance policies, and/or a common weakness enumeration (CWE) system corresponding to respective compliance policies. For example, policy analyzer component 108 can employ a natural language extraction process defined above and/or a model that has been trained (e.g., via trainer component 202 as described below with reference to FIG. 2) to identify such similarities based on such a cosine similarity. In some embodiments, policy analyzer component 108 can employ a model defined above and/or a natural language extraction process to identify such similarities between a certain new compliance policy and existing compliance policies (e.g., historical compliance policies), where dependency relationships and/or corresponding directions of such dependency relationships between such existing compliance policies are known (e.g., dependency relationships and/or corresponding dependency relationship direction(s) that have been verified by, for instance, an expert entity, operational data, etc.). In some embodiments, for example, where policy analyzer component 108 identifies one or more such similarities defined above between a certain new compliance policy and a certain existing compliance policy that has one or more dependency relationships with one or more other existing compliance policies, policy analyzer component 108 can determine that the new compliance policy has the same one or more dependency relationships and/or corresponding dependency relationship direction(s) with such other existing compliance policies.

Policy analyzer component 108 can identify one or more dependency relationships and/or corresponding dependency relationship direction(s) based on at least one of expert feedback or operational data feedback. In some embodiments, policy analyzer component 108 can employ such a model defined above to identify one or more dependency relationships and/or corresponding dependency relationship direction(s) based on at least one of expert feedback or operational data feedback. For example, policy analyzer component 108 can employ such a model defined above to identify one or more dependency relationships and/or corresponding dependency relationship direction(s) based on expert feedback provided by an expert entity including, but not limited to, a human, a computing device, a software application, an expert agent, a machine learning (ML) model, an artificial intelligence (AI) model, and/or another expert entity. In some embodiments, policy analyzer component 108 can identify a compliance policy dependency relationship and/or corresponding dependency relationship direction and provide the same to such an expert entity to verify (e.g., validate or invalidate) the accuracy of such dependency relationship and/or corresponding direction. For example, such an expert entity can verify the accuracy based on, for instance, human experience (e.g., experience of a human expert such as, for instance, a subject matter expert (SME)), compliance policy dependency relationship(s) and/or corresponding dependency relationship direction(s) between existing compliance policies that have been previously verified (e.g., by the expert entity), and/or other data.

In some embodiments, compliance policy management and scheduling system 102 can present to such an expert entity defined above one or more dependency relationships and/or corresponding dependency relationship direction(s) identified by policy analyzer component 108 and/or receive feedback data from such an expert entity corresponding to the dependency relationship(s) and/or corresponding direction(s) identified by policy analyzer component 108. For example, compliance policy management and scheduling system 102 can comprise an interface component including, but not limited to, an application programming interface (API), a graphical user interface (GUI), and/or another interface component that can present (e.g., via a computer monitor, a display, a screen, etc.) to such an expert entity defined above the dependency relationship(s) and/or corresponding direction(s) identified by policy analyzer component 108 and/or receive feedback data from the expert entity corresponding to the dependency relationship(s) and/or corresponding direction(s) identified by policy analyzer component 108. For instance, compliance policy management and scheduling system 102 can comprise an interface component that can present such dependency relationship data and/or corresponding direction data to such an expert entity by displaying it on a computer monitor, for example, and/or can receive feedback data from the expert entity via one or more input controls of such an interface component (e.g., input controls of a GUI) such as, for example, a text field, a button, a seek bar, a checkbox, a toggle button, a zoom button, and/or another input control.

The policy analyzer component 108 can employ such a model defined above to identify one or more dependency relationships and/or corresponding dependency relationship direction(s) based on operational data feedback, where such operational data feedback can comprise data associated with operational results from executing codes of compliance policies previously determined to be dependent on each other. For example, policy analyzer component 108 can employ such a model defined above to identify one or more dependency relationships and/or corresponding dependency relationship direction(s) based on operational data feedback including, but not limited to, service tickets, request tickets, incidents, and/or other operational data feedback associated with operational results from executing codes of compliance policies previously determined to be dependent on each other.

In some embodiments, such feedback data from an expert entity and/or from operational data described above can comprise historical data corresponding to one or more dependency relationships and/or corresponding dependency relationship direction(s) that can be identified by policy analyzer component 108 (e.g., as described above). In some embodiments, compliance policy management and scheduling system 102, policy analyzer component 108, and/or trainer component 202 can compile such historical data into a historical data index (e.g., a log) that can be stored on a memory device such as, for instance, memory 104 and/or a remote memory device (e.g., a memory device of a remote server). In some embodiments, such historical data can comprise training data that policy analyzer component 108 can use to learn (e.g., via active learning, explicit learning, implicit learning, etc.) to identify one or more dependency relationships and/or corresponding dependency relationship direction(s) between compliance policies.

The policy analyzer component 108 can employ a model defined above that can ingest such historical data defined above (e.g., expert entity feedback, operational data feedback, etc.) to learn one or more dependency relationships and/or corresponding dependency relationship direction(s) between compliance policies based on explicit learning and/or implicit learning. For instance, policy analyzer component 108 can employ a model defined above to learn such one or more dependency relationships and/or corresponding dependency relationship direction(s) based on explicit learning (e.g., supervised learning, reinforcement learning, etc.) using previously obtained historical data defined above. In another example, policy analyzer component 108 can employ a model defined above to learn such one or more dependency relationships and/or corresponding dependency relationship direction(s) based on implicit learning (e.g., unsupervised learning) using feedback data defined above (e.g., expert entity feedback, operational data feedback, etc.).

In some embodiments, policy analyzer component 108 can employ a model defined above to learn such one or more dependency relationships and/or corresponding dependency relationship direction(s) between compliance policies based on classifications, correlations, inferences and/or expressions associated with principles of artificial intelligence. For instance, policy analyzer component 108 can employ an automatic classification system and/or an automatic classification process to learn such one or more dependency relationships and/or corresponding dependency relationship direction(s) based on feedback data (e.g., expert entity feedback, operational data feedback, etc.). In one embodiment, policy analyzer component 108 can employ a probabilistic and/or statistical-based analysis (e.g., factoring into the analysis utilities and costs) to learn such one or more dependency relationships and/or corresponding dependency relationship direction(s) based on feedback data (e.g., expert entity feedback, operational data feedback, etc.).

The policy analyzer component 108 can employ any suitable machine learning based techniques, statistical-based techniques, and/or probabilistic-based techniques to learn such one or more dependency relationships and/or corresponding dependency relationship direction(s) based on feedback data (e.g., expert entity feedback, operational data feedback, etc.). For example, policy analyzer component 108 can employ an expert system, fuzzy logic, support vector machine (SVM), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or another model. In some embodiments, policy analyzer component 108 can perform a set of machine learning computations associated with learning such one or more dependency relationships and/or corresponding dependency relationship direction(s) based on feedback data (e.g., expert entity feedback, operational data feedback, etc.). For example, policy analyzer component 108 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations to learn such one or more dependency relationships and/or corresponding dependency relationship direction(s) based on feedback data (e.g., expert entity feedback, operational data feedback, etc.).

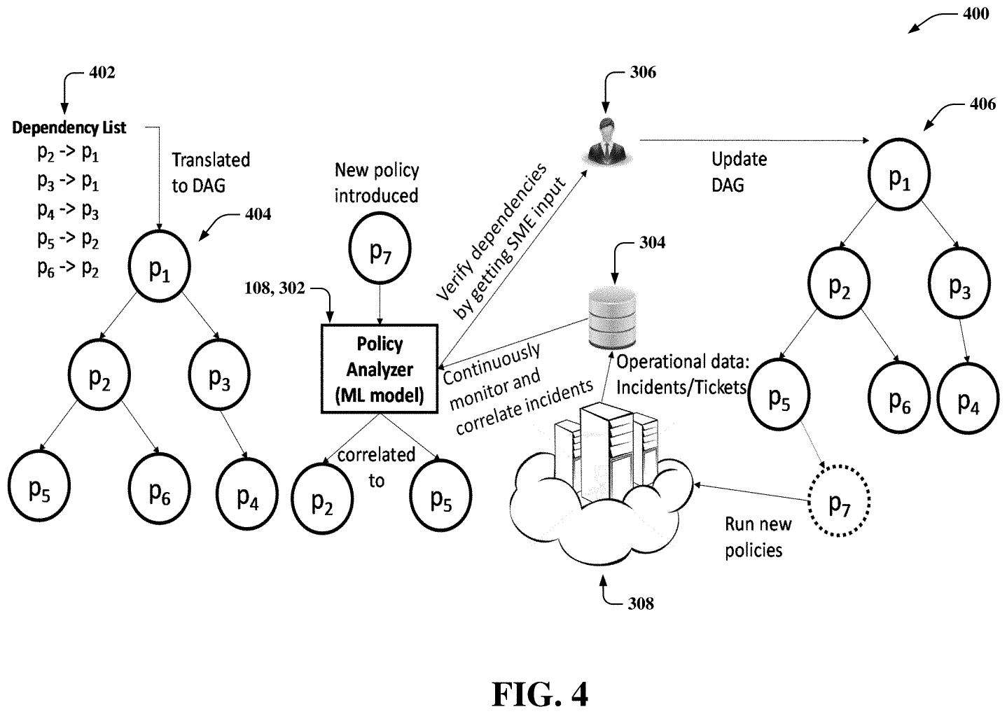

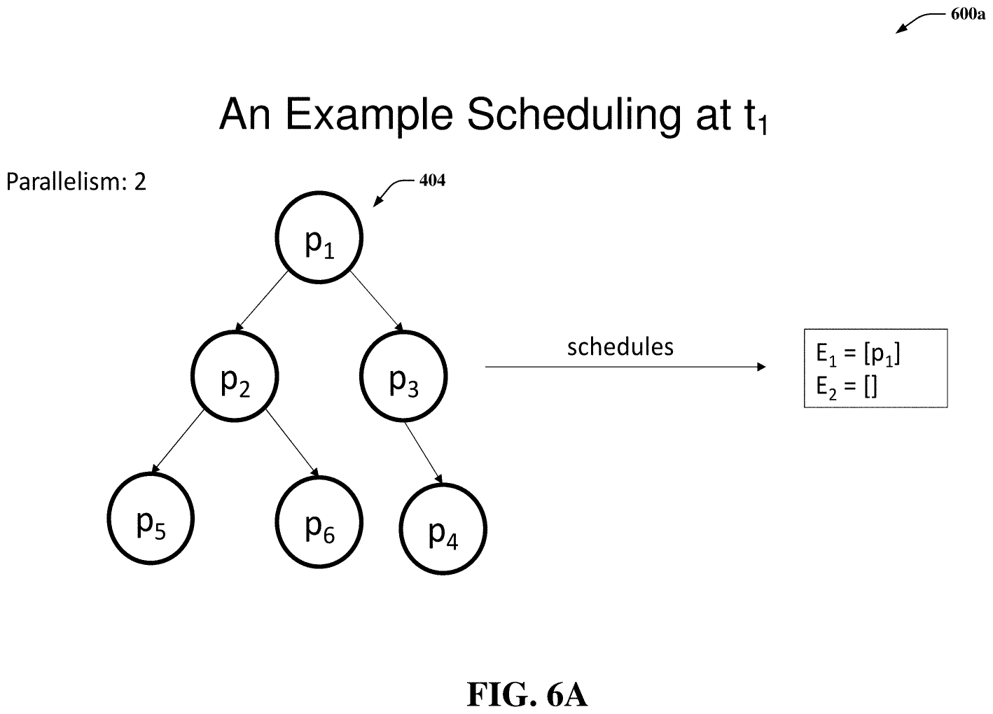

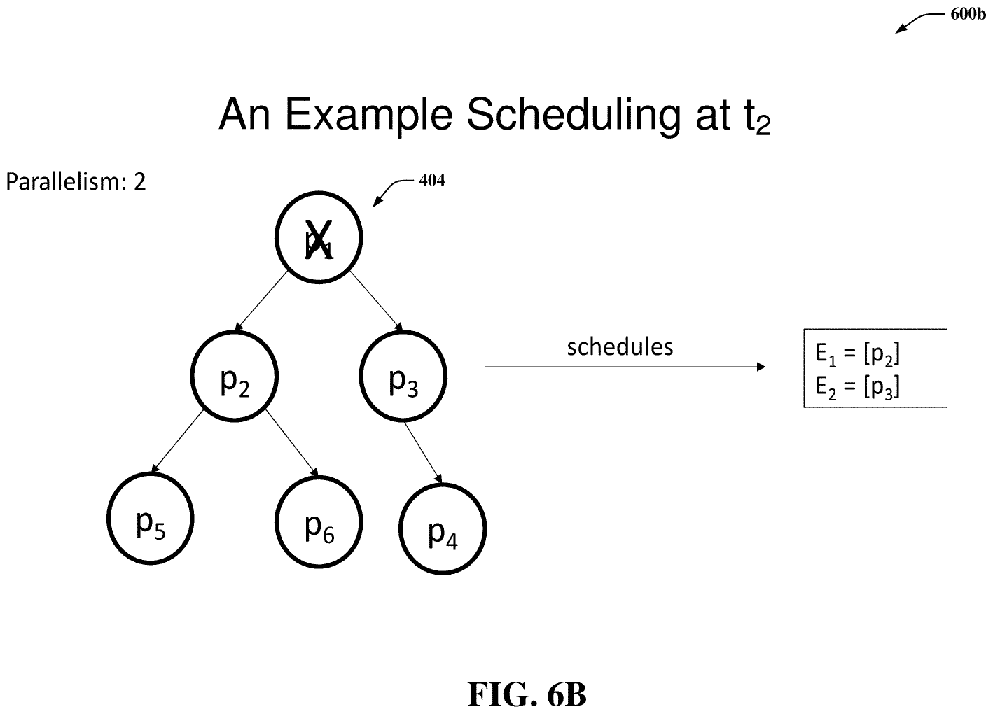

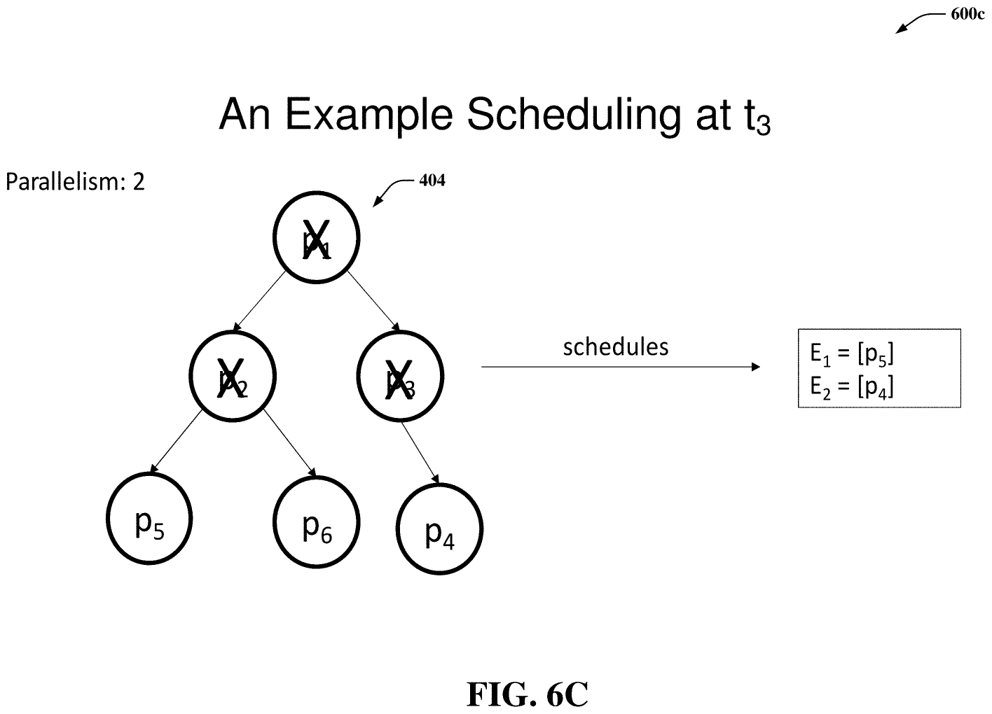

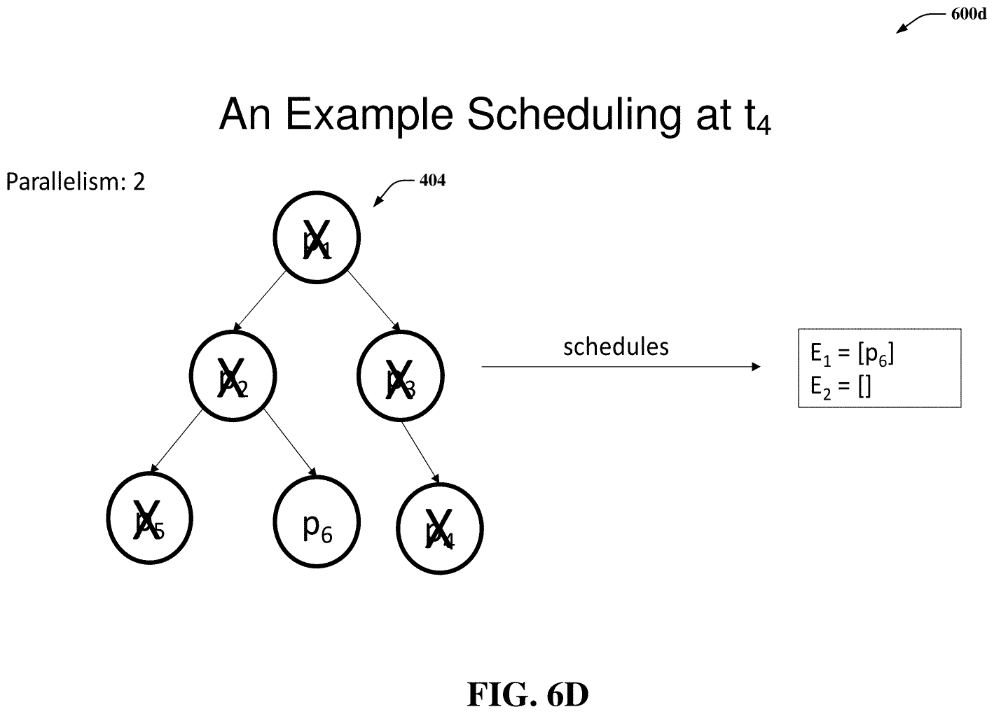

According to multiple embodiments, scheduler component 110 can generate a policy execution plan (e.g., a run list) based on one or more dependency relationships. For example, scheduler component 110 can generate a policy execution plan based on one or more dependency relationships and/or corresponding dependency relationship direction(s) that can be expressed visually in the form of a directed acyclic graph (DAG). For instance, scheduler component 110 can generate a policy execution plan based on one or more dependency relationships and/or corresponding dependency relationship direction(s) that can be expressed visually in the form of one or more of the directed acyclic graphs (DAG) illustrated in FIGS. 4, 6A, 6B, 6C, and/or 6D.

In some embodiments, scheduler component 110 can generate such a directed acyclic graph (DAG) using one or more mapping techniques. For example, scheduler component 110 can employ one or more graph mapping techniques to generate a DAG such as, for instance, DAG 404 illustrated in FIG. 4, where compliance policies of such a DAG can be represented as nodes and compliance policy dependency relationships of such a DAG can be represented as arrows indicative of edges that denote directions of dependency relationships between such compliance policies. In some embodiments, scheduler component 110 can employ one or more graph mapping techniques (e.g., one or more graph mapping algorithms) to map such compliance policies and such compliance policy dependency relationships to a DAG model by mapping such policies and dependency relationships to a graph problem.

The scheduler component 110 can generate a policy execution plan that can be expressed as execution E₁=[P₁, P₂, P₉], where compliance policies P₁, P₂, P₉, can be dependent on one another and can be executed sequentially. In some embodiments, scheduler component 110 can generate a parallel policy execution plan to execute at least two compliance policies simultaneously based on one or more dependency relationships. For instance, scheduler component 110 can generate a parallel policy execution plan that can be expressed as execution E₁=[P₁, P₂, P₉] and executed E₂=[P₄, P₇, P₈]. where compliance policies P₁, P₂, P₉ can be independent of and executed simultaneously with compliance policies P₄, P₇, P₈.

In some embodiments, scheduler component 110 can generate an updated directed acyclic graph (DAG) based on at least one of expert feedback, operational data feedback, or one or more dependency relationships. For example, scheduler component 110 can generate an updated DAG based on one or more dependency relationships and/or corresponding dependency relationship direction(s) that have been identified by policy analyzer component 108 as described above. In another example, scheduler component 110 can generate an updated DAG based on one or more dependency relationships and/or corresponding dependency relationship direction(s) that have been validated or invalidated by an expert entity as described above, In another example, scheduler component 110 can generate an updated DAG based on one or more dependency relationships and/or corresponding dependency relationship direction(s) that have been validated or invalidated based on operational data feedback defined above. In some embodiments, scheduler component 110 can generate an updated DAG comprising updated directed acyclic graph (DAG) 406 illustrated in FIG. 4 and described below, In some embodiments, scheduler component 110 can employ such an updated DAG described above to generate a policy execution plan. For example, scheduler component 110 can employ such an updated DAG described above to generate a parallel policy execution plan described above.

In an implementation, the scheduler component 110 can generate a policy execution plan based on one or more dependency relationships and/or corresponding dependency relationship direction(s) using, for instance, algorithm (1) defined below. In some embodiments, more complex scheduling algorithms based on the priority of policies or the length of execution of policies can also be adopted. In some embodiments, scheduler component 110 can generate a policy execution plan based on one or more dependency relationships and/or corresponding dependency relationship direction(s) using, for instance, algorithm (1) defined below, which can comprise an illustration of how scheduling can be performed given the parallelism and the policy dependencies.

Algorithm (1)

Inputs: a given dependency tree for compliance policies (e.g., a dependency tree comprising compliance policies P₁, P₂, P₃, P₄, P₅, P₇, P₈, P₉, and/or P₁₀) and number of execution N paths (also referred to as parallelism).

Ready List R={Policies with no predecessor},

While R is not empty:
Schedule each policy in R to the available execution path.
Update R.

Output:
E₁={P₁, P₇, P₉};
E₂={P₂, P₄, P₁₀}; and
E₃={P₃, P₅, P₈}.

FIG. 2 illustrates a block diagram of an example, non-limiting system 200 that can facilitate compliance policy management and scheduling in accordance with one or more embodiments described herein. In some embodiments, system 200 can comprise compliance policy management and scheduling system 102. In some embodiments, compliance policy management and scheduling system 102 can comprise a trainer component 202. Repetitive description of like elements and/or processes employed in respective embodiments is omitted for sake of brevity.

According to multiple embodiments, trainer component 202 can train a model to identify one or more dependency relationships and/or corresponding dependency relationship direction(s) between a first compliance policy and one or more second compliance policies based on at least one of dependency data corresponding to historical compliance policies, expert feedback, or operational data feedback. For example, trainer component 202 can train a model defined above to identify one or more dependency relationships between compliance policies and corresponding dependency relationship direction(s) based on; a) dependency data corresponding to historical compliance policies (e.g., dependency relationship(s) and/or corresponding dependency relationship direction(s) between historical compliance policies that have been validated or invalidated); b) expert feedback (e.g., where such training can be performed via active learning using expert entity feedback as described above with reference to FIG. 1); and/or operational data feedback (e.g., where such training can be performed via active learning using expert entity feedback as described above with reference to FIG. 1).

In some embodiments, trainer component 202 can train a model defined above to learn one or more dependency relationships and/or corresponding dependency relationship direction(s) between compliance policies based on explicit learning and/or implicit learning. For instance, trainer component 202 can train a model defined above to learn one or more dependency relationships and/or corresponding dependency relationship direction(s) between compliance policies based on explicit learning (e.g., supervised learning, reinforcement learning, etc.) using previously obtained historical data defined above (e.g., dependency data corresponding to historical compliance policies). In another example, trainer component 202 can train a model defined above to learn one or more dependency relationships anchor corresponding dependency relationship direction(s) between compliance policies based on implicit learning (e.g., unsupervised learning) using feedback data defined above (e.g., expert entity feedback, operational data feedback, etc.).

The trainer component 202 can train a model defined above to learn one or more dependency relationships and/or corresponding dependency relationship direction(s) between compliance policies based on classifications, correlations, inferences and/or expressions associated with principles of artificial intelligence. For instance, trainer component 202 can train a model defined above to learn one or more dependency relationships and/or corresponding dependency relationship direction(s) between compliance policies based on previously obtained historical data defined above (e.g., dependency data corresponding to historical compliance policies, expert feedback, and/or operational data feedback). In one embodiment, trainer component 202 can employ a probabilistic and/or statistical-based analysis (e.g., factoring into the analysis utilities and costs) to train a model defined above to learn one or more dependency relationships and/or corresponding dependency relationship direction(s) between compliance policies based on previously obtained historical data defined above (e.g., dependency data corresponding to historical compliance policies, expert feedback, and/or operational data feedback).

In some embodiments, trainer component 202 can employ any suitable machine learning based techniques, statistical-based techniques, and/or probabilistic-based techniques to train a model defined above to learn one or more dependency relationships and/or corresponding dependency relationship direction(s) between compliance policies based on previously obtained historical data defined above (e.g., dependency data corresponding to historical compliance policies, expert feedback, and; or operational data feedback). For example, trainer component 202 can employ an expert system, fuzzy logic, support vector machine (SVM), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or another model. In some embodiments, trainer component 202 can perform a set of machine learning computations associated with training a model defined above to learn such one or more dependency relationships and/or corresponding dependency relationship direction(s) based on previously obtained historical data defined above (e.g., dependency data corresponding to historical compliance policies, expert feedback, and/or operational data feedback). For example, trainer component 202 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations to train a model defined above to learn one or more dependency relationships and/or corresponding dependency relationship direction(s) between compliance policies based on previously obtained historical data defined above (e.g., dependency data corresponding to historical compliance policies, expert feedback, and; or operational data feedback).

In some embodiments, trainer component 202 can train a model defined above to learn one or more dependency relationships and/or corresponding dependency relationship direction(s) between compliance policies based on previously obtained historical data defined above (e.g., dependency data corresponding to historical compliance policies, expert feedback, and/or operational data feedback) using, for instance, algorithm (2) defined below.

Algorithm (2)

Input: previously submitted compliance policy description and corresponding code pairs {{Dᵢ, Dⱼ,} {Cᵢ, Cⱼ}} and their associated labels Lᵢⱼ {1, 0}, where the label designations 1 and 0 can represent dependency or not and direction of dependency.

For each compliance policy pairs (Pᵢ, Pⱼ):

Calculate text similarity T_{i,j} and code similarity C_{i,j} scores for description D and code C. For example, calculate text similarity by calculating cosine similarity using equation (1) below.

$$sim ( A , B ) = cos ( θ ) = \frac{A \cdot B}{‖ A ‖ ‖ B ‖} \qquad ( 1 )$$

Store {T_{i,j}, C_{i,j}} as a feature vector in a list X, where list X can be stored on a memory device such as, for instance, memory 104 and/or a remote memory device a memory device of a remote server).

Store Lᵢⱼ in a list Y, where list Y can be stored on a memory device such as, for instance, memory 104 and/or a remote memory device (e.g., a memory device of a remote server).

Train a model (e.g., a support vector machine (SVM) model) using list X as input and list Y as output.

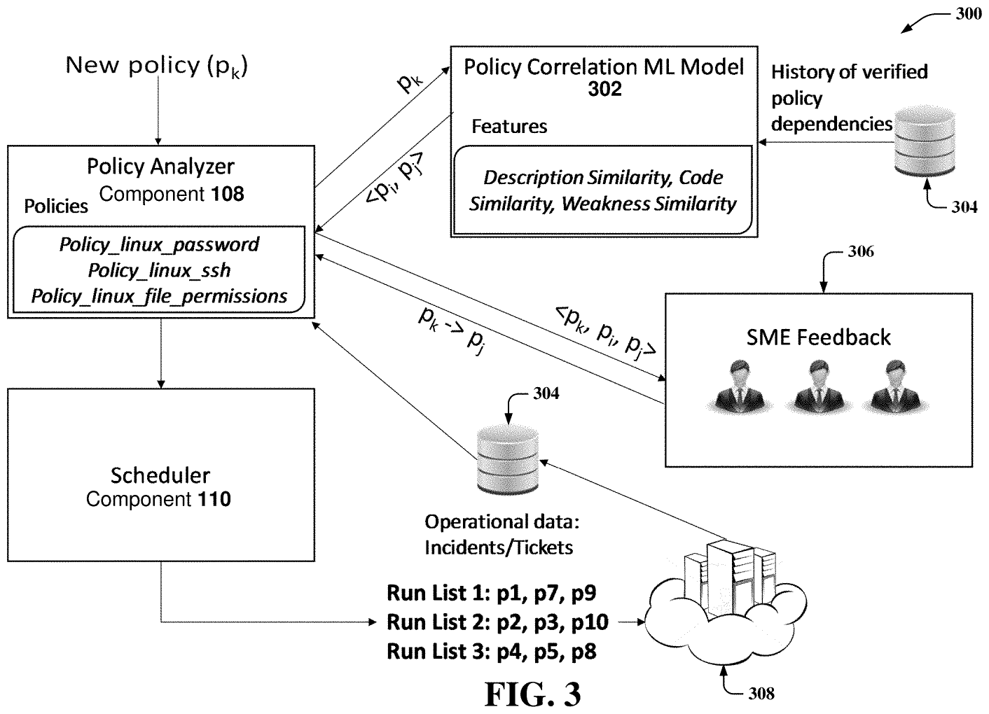

FIG. 3 illustrates a diagram of an example, non-limiting system 300 that can facilitate compliance policy management and scheduling in accordance with one or more embodiments described herein. Repetitive description of like elements and/or processes employed in respective embodiments is omitted for sake of brevity.

In some embodiments, system 300 can comprise an example, non-limited alternative embodiment of system 100 and/or system 200. In some embodiments, system 300 can comprise policy analyzer component 108, scheduler component 110, a policy correlation machine learning (ML) model 302, one or more databases 304, one or more expert entities 306 (denoted in FIG. 3 as SME Feedback to represent subject matter expert (SME) feedback), and/or a cloud computing environment 308.

According to multiple embodiments, policy analyzer component 108 can comprise one or more compliance policies (denoted in FIG. 3 as Policy_linux_password, Policy_linux_ssh, and Policy_linux_file_permissions). In some embodiments, policy analyzer component 108 can receive a new compliance policy (denoted in FIG. 3 as New policy (Pₖ). In some embodiments, policy analyzer component 108 can employ policy correlation ML model 302 to identify one or more dependency relationships and/or corresponding dependency relationship direction(s) between such a new compliance policy Pₖ and one or more existing compliance policies denoted as Pᵢ, Pⱼ in FIG. 3 (e.g., the one or more compliance policies defined above).

In some embodiments, policy correlation ML model 302 can comprise a model including, but not limited to, a machine learning (ML) model, an artificial intelligence (AI) model, a neural network model, a support vector machine (SVM) model, a supervised learning model, a classification model, a regression analysis model, a non-probabilistic binary linear classifier model, and/or another model. In some embodiments, policy correlation ML model 302 can comprise a model defined above that has been trained (e.g., via trainer component 202 as described above with reference to FIG. 2) to identify one or more dependency relationships between compliance policies and corresponding dependency relationship direction(s) based on a history of verified policy dependencies that can be stored in database 304 as illustrated in FIG. 3. In some embodiments, such a history of verified policy dependencies can comprise dependency data corresponding to historical compliance policies (e.g., dependency relationship(s) and/or corresponding dependency relationship direction(s) between historical compliance policies that have been validated or invalidated). In some embodiments, policy correlation ML model 302 can comprise a model defined above that has been trained (e.g., via trainer component 202 as described above with reference to FIG. 2) to identify one or more dependency relationships between compliance policies and corresponding dependency relationship direction(s) based on one or more features such as, for example, compliance policy description similarity (denoted as Description Similarity in FIG. 3), compliance policy code similarity (denoted as Code Similarity in FIG. 3), and/or compliance policy weakness similarity (denoted as Weakness Similarity in FIG. 3) as described above with reference to FIG. 1.

According to multiple embodiments, expert entity 306 can comprise an expert entity including, but not limited to, a human (e.g., a subject matter expert (SME), etc), a computing device, a software application, an expert agent, a machine learning (ML) model, an artificial intelligence (AI) model, and/or another expert entity. In some embodiments, policy analyzer component 108 can employ expert entity 306 to validate and/or invalidate one or more dependency relationships between compliance policies and/or corresponding dependency relationship direction(s) that have been identified by policy analyzer component 108 and/or policy correlation ML model 302. For example, policy analyzer component 108 can employ expert entity 306 to validate and/or invalidate one or more dependency relationships and/or corresponding dependency relationship direction(s) between new compliance policy Pₖ and the one or more existing compliance policies Pᵢ, Pⱼ that have been identified by policy analyzer component 108 and/or policy correlation ML model 302. For instance, expert entity 306 can validate and/or invalidate such one or more dependency relationships between compliance policies and/or corresponding dependency relationship direction(s) based on, for example, human experience (e.g., experience of a human expert such as, for instance, a subject matter expert (SME)), compliance policy dependency relationship(s) and/or corresponding dependency relationship direction(s) between existing compliance policies that have been previously verified (e.g., by expert entity 306), and/or other data. In an example, as illustrated in FIG. 3, expert entity 306 can validate a dependency relationship between new compliance policy Pₖ and existing compliance policy Pⱼ, as well as a direction of such dependency relationship, which can be denoted as Pₖ→Pⱼ to indicate that new compliance policy Pₖ is dependent on existing compliance policy Pⱼ, as illustrated in FIG. 3.

In some embodiments, based on receiving from policy analyzer component 108 such one or more dependency relationships and/or corresponding dependency relationship direction(s) that have been identified by policy analyzer component 108 (e.g., via policy correlation ML model 302) and/or validated by expert entity 306, scheduler component 110 can generate one or more policy execution plans that can be executed by one or more computing resources of cloud computing environment 308. For example, scheduler component 110 can generate a parallel policy execution plan comprising Run List 1, Run List 2, and Run List 3 as illustrated in FIG. 3, where compliance policies of each of such run lists can have dependency relationships with one another but not with compliance policies of the other run lists. For instance, as illustrated in FIG. 3, scheduler component 110 can generate a parallel policy execution plan comprising Run list 1, Run List 2, and Run List 3, where compliance policies P₁, P₇, P₉ of Run List 1 can have dependency relationships with one another but not with compliance policies P₂, P₃, P₁₀ or compliance policies P₄, P₅, P₈ of Run List 2 and Run List 3, respectively.

According to multiple embodiments, cloud computing environment 308 can comprise cloud computing environment 950 described below with reference to FIG. 9 and/or one or more functional abstraction layers described below with reference to FIG. 10 (e.g., hardware and software layer 1060, virtualization layer 1070, management layer 1080, and/or workloads layer 1090). In some embodiments, multiple different computing resources of cloud computing environment 308 can execute compliance policies of Run List 1, Run List 2, and Run List 3 simultaneously (e.g., execute code corresponding to such compliance policies). For example: code corresponding to compliance policies P₁, P₇, P₉ of Run List 1 can be executed by a first computing resource of cloud computing environment 308; code corresponding to compliance policies P₂, P₃, P₁₀ of Run List 2 can be executed by a second computing resource of cloud computing environment 308; and/or code corresponding to compliance policies P₄, P₅, P₈ of Run List 3 can be executed by a third computing resource of cloud computing environment 308.

In some embodiments, based on execution (e.g., via one or more computing resources of cloud computing environment 308) of code corresponding to compliance policies, operational data indicative of operational results from executing such compliance policies including, but not limited to, incident reports, service tickets, request tickets, and/or other operational data can be compiled and/or stored on a database. For example, one or more computing resources of cloud computing environment 308 can compile and/or store such operational data on database 304 as illustrated in FIG. 3. In some embodiments, policy analyzer component 108 can collect (e.g., from database 304) and/or use such operational data as training data to actively learn (e.g., as described above with reference to FIGS. 1 and 2) to identify one or more dependency relationships and/or corresponding dependency relationship direction(s) between a subsequently received new compliance policy and existing compliance policies.

FIG. 4 illustrates a diagram of an example, non-limiting system 400 that can facilitate compliance policy management and scheduling in accordance with one or more embodiments described herein. Repetitive description of like elements and/or processes employed in respective embodiments is omitted for sake of brevity.

In some embodiments, system 400 can comprise an example, non-limited alternative embodiment of system 100, system 200, and/or system 300. In some embodiments, system 400 can comprise a dependency list 402, a directed acyclic graph (DAG) 404, policy analyzer component 108 (denoted as Policy Analyzer in FIG. 4), scheduler component 110 (not illustrated in FIG. 4), policy correlation ML model 302 (denoted as ML model in FIG. 4), database 304, expert entity 306, cloud computing environment 308, anchor an updated directed acyclic graph (DAG) 406.

In some embodiments, policy analyzer component 108 and/or policy correlation ML model 302 can generate dependency list 402 by identifying one or more dependency relationships and/or corresponding dependency relationship direction(s) between existing compliance policies P₁, P₂, P₃, P₄, P₅, and P₆ as illustrated in FIG. 4 and described above with reference to FIGS. 1, 2, and 3. In some embodiments, scheduler component 110 can generate (e.g., as described above with reference to FIG. 1) DAG 404 based on dependency list 402.

In some embodiments, based on receiving a new compliance policy P₇, policy analyzer component 108 (e.g., via policy correlation ML model 302) can identify (e.g., as described above with reference to FIGS. 1, 2, and 3) one or more dependency relationships (denoted as correlated to in FIG. 4) and/or corresponding dependency relationship direction(s) between new compliance policy P₇ and existing compliance policies P₂ and P₅ as illustrated in FIG. 4. In some embodiments, expert entity can validate or invalidate such one or more dependency relationships and/or corresponding dependency relationship direction(s) identified by policy analyzer component 108 (e.g., via policy correlation ML model 302) between new compliance policy P₁ and existing compliance policies P₂ and P₅ as illustrated in FIG. 4.

In some embodiments, for example, where expert entity 306 validates such one or more dependency relationships and/or corresponding dependency relationship direction(s) between new compliance policy P₇ and existing compliance policies P₂ and P₅, scheduler component 110 can generate updated directed acyclic graph (DAG) 406 reflecting such dependency relationship(s) and/or corresponding dependency relationship direction(s) as illustrated in FIG. 4. In these embodiments, scheduler component 110 can further generate (e.g., via a graph mapping technique as described above with reference to FIG. 1) one or more policy execution plans (e.g. parallel policy execution plans) based on the compliance policy dependency relationships and corresponding dependency relationship directions depicted in updated directed acyclic graph (DAG) 406.

In some implementations, multiple different computing resources of cloud computing environment 308 can simultaneously execute code corresponding to compliance policies of such policy execution plan(s) that can be generated by scheduler component 110 based on updated directed acyclic graph (DAG) 406 (e.g., as described above). In some embodiments, based on execution (e.g., via one or more computing resources of cloud computing environment 308) of code corresponding to compliance policies of such policy execution plan(s) that can be generated by scheduler component 110, operational data indicative of operational results from executing such compliance policies (e.g., incident reports, service tickets, request tickets, etc.) can be compiled and/or stored on database 304 as described above with reference to FIG. 3. In some embodiments, policy analyzer component 108 can collect (e.g., from database 304) and/or use such operational data as training data to actively learn (e.g., as described above with reference to FIGS. 1, 2, and 3) to identify one or more dependency relationships and/or corresponding dependency relationship direction(s) between a subsequently received new compliance policy and existing compliance policies.

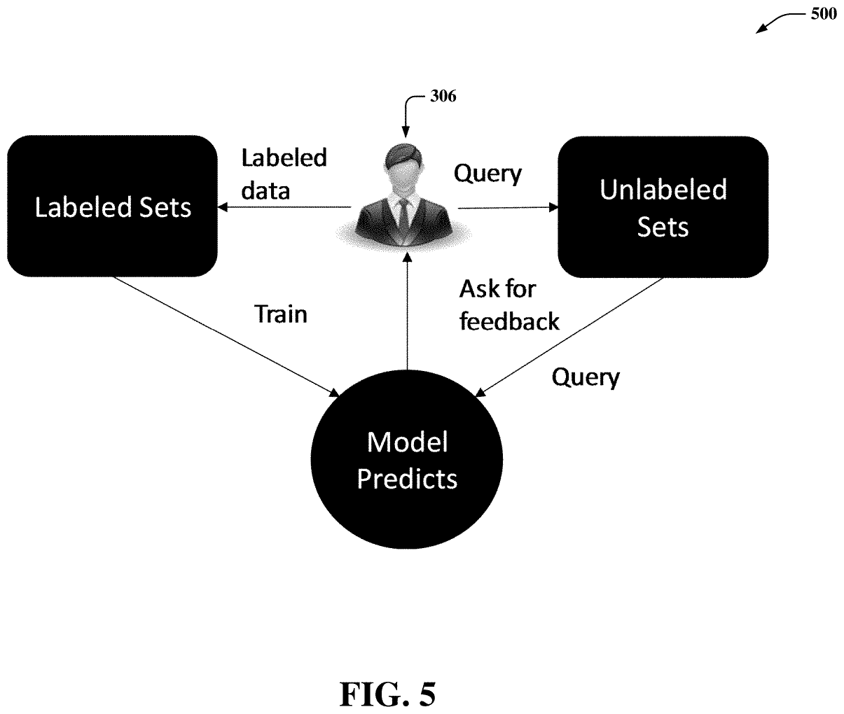

FIG. 5 illustrates a diagram of an example, non-limiting system 500 that can facilitate compliance policy management and scheduling in accordance with one or more embodiments described herein, Repetitive description of like elements and/or processes employed in respective embodiments is omitted for sake of brevity.

In some embodiments, system 500 can comprise an illustration of how compliance policy management and scheduling system 102 (e.g., via policy analyzer component 108, policy correlation ML model 302, expert entity 306, etc.) can actively learn to classify one or more compliance policy dependency relationships and/or corresponding dependency relationship direction(s) between compliance policies in accordance with one or more embodiments of the subject disclosure described herein. For example, system 500 can comprise an illustration of how compliance policy management and scheduling system 102 (e.g., via policy analyzer component 108, policy correlation ML model 302, expert entity 306, etc.) can actively learn to classify such one or more compliance policy dependency relationships and/or corresponding dependency relationship direction(s) between compliance policies using, for instance, algorithm (3) defined below.

Algorithm (3)

Inputs: Labeled set Dₗ, submitted policy Pᵢ.

Train a classifier fₗ based on training data Dₗ.

while True
Predict a label for a given code C based on code and description similarity.
Use feedback/operational data to validate that code C worked or not {l₁, l₂}.
Update training data (Dₗ) with policy Pᵢ and its label.
Retrain a classifier fᵢ using Dₗ.

FIGS. 6A, 6B, 6C, and 6D illustrate diagrams of example, non-limiting systems 600a, 600b, 600c, 600d, respectively, that can facilitate compliance policy management and scheduling in accordance with one or more embodiments described herein. Repetitive description of like elements and/or processes employed in respective embodiments is omitted for sake of brevity.

In some embodiments, system 600a (FIG. 6A) can comprise an example scheduling of compliance policy executions at a time t₁ (e.g., a time before execution of any compliance policy). In some embodiments, such scheduling can be performed by scheduler component 110 (e.g., as described above with reference to FIGS. 1, 3, and 4) based on directed acyclic graph (DAG) 404 and a parallelism of 2 (e.g., 2 computing resources available to simultaneously execute code corresponding to compliance policies). For example, at a time scheduler component 110 can schedule simultaneous execution of compliance policies of execution plans E₁ and E₂ illustrated in FIG. 6A. In this example, execution plan E₁ can comprise compliance policy P₁ that can be executed by a first computing resource (e.g., a first computing resource of cloud computing environment 308) and execution plan E₂ can comprise no compliance policies, as compliance policies P₂ and P₃ are dependent on compliance policy P₁, and therefore, compliance policy P₁ must be executed prior to execution of compliance policies P₂ and/or P₃.

In some embodiments, system 600b (FIG. 6B) can comprise an example scheduling of compliance policy executions at a time t₂ (e.g., a time after execution of compliance policy P₁, where completion of such execution is denoted in FIG. 6B by the X over the compliance policy P₁ of directed acyclic graph (DAG) 404), In some embodiments, such scheduling can be performed by scheduler component 110 (e.g., as described above with reference to FIGS. 1, 3, and 4) based on directed acyclic graph (DAG) 404 and a parallelism of 2 (e.g., 2 computing resources available to simultaneously execute code corresponding to compliance policies). For example, at a time t₂, scheduler component 110 can schedule simultaneous execution of compliance policies of execution plans E₁ and E₂ illustrated in FIG. 6B. In this example, execution plan E₁ can comprise compliance policy P₂ that can be executed by a first computing resource (e.g., a first computing resource of cloud computing environment 308) and execution plan E₂ can comprise compliance policy P₃ that can be executed simultaneously with compliance policy P₂ by a second computing resource (e.g., a second computing resource of cloud computing environment 308).

System 600c (FIG. 6C) can comprise an example scheduling of compliance policy executions at a time t₃ (e.g., a time after execution of compliance policies P₂ and P₃, where completion of such execution is denoted in FIG. 6C by the X over each of the compliance policies P₂ and P₃ of directed acyclic graph (DAG) 404). In some embodiments, such scheduling can be performed by scheduler component 110 (e.g., as described above with reference to FIGS. 1, 3, and 4) based on directed acyclic graph (DAG) 404 and a parallelism of 2 (e.g., 2 computing resources available to simultaneously execute code corresponding to compliance policies). For example, at a time t₃, scheduler component 110 can schedule simultaneous execution of compliance policies of execution plans E₁ and E₂ illustrated in FIG. 6C. In this example, execution plan E₁ can comprise compliance policy P₅ that can be executed by a first computing resource (e.g., a first computing resource of cloud computing environment 308) and execution plan E₂ can comprise compliance policy P₄ that can be executed simultaneously with compliance policy P₅ by a second computing resource (e.g., a second computing resource of cloud computing environment 308).

In some embodiments, system 600d (FIG. 6D) can comprise an example scheduling of compliance policy executions at a time t₄ (e.g., a time after execution of compliance policies P₅ and P₄, where completion of such execution is denoted in FIG. 6D by the X over each of the compliance policies P₅ and P₄ of directed acyclic graph (DAG) 404). In some embodiments, such scheduling can be performed by scheduler component 110 (e.g., as described above with reference to FIGS. 1, 3, and 4) based on directed acyclic graph (DAG) 404 and a parallelism of 2 (e.g., 2 computing resources available to simultaneously execute code corresponding to compliance policies). For example, at a time t₄, scheduler component 110 can schedule simultaneous execution of compliance policies of execution plans E₁ and E₂ illustrated in FIG. 6D. In this example, execution plan E₁ can comprise compliance policy P₆ that can be executed by a first computing resource (e.g., a first computing resource of cloud computing environment 308) and execution plan E₂ can comprise no compliance policies as compliance policy P₆ is the only remaining compliance policy of directed acyclic graph (DAG) 404 that has yet to be executed.

Compliance policy management and scheduling system 102 can be associated with various technologies. For example, compliance policy management and scheduling system 102 can be associated with artificial intelligence technologies, machine learning technologies, compliance policy management and scheduling, data analytics technologies, computer technologies, server technologies, information technology (IT) technologies, Internet-of-things IoT) technologies, automation technologies, and/or other technologies.

In some embodiments, compliance policy management and scheduling system 102 can provide technical improvements to systems, devices, components, operational steps, and/or processing steps associated with the various technologies identified above. For example, compliance policy management and scheduling system 102 can automatically: identify (e.g., via employing a model defined above with reference to FIGS. 1, 2, 3, 4, and 5) one or more dependency relationships between a first compliance policy and one or more second compliance policies; and/or generate a policy execution plan based on the one or more dependency relationships, where such policy execution plan can comprise a parallel policy execution plan to execute at least two compliance policies simultaneously based on the one or more dependency relationships. In this example, by generating such a parallel policy execution plan to execute at least two compliance policies simultaneously based on the one or more dependency relationships, compliance policy management and scheduling system 102 can facilitate reduced latency of the computing devices that execute the at least two compliance policies.

In another example, compliance policy management and scheduling system 102 can automatically: generate an updated directed acyclic graph based on at least one of expert feedback, operational data feedback, or the one or more dependency relationships; and/or employ the updated directed acyclic graph to generate the policy execution plan (e.g., the parallel policy execution plan described above). In this example, by generating such an updated directed. acyclic graph and/or such a policy execution plan based on the updated directed acyclic graph, compliance policy management and scheduling system 102 can facilitate at least one of improved accuracy, efficiency, or performance of at least one of a scheduler component that generates the policy execution plan, a processor associated with compliance policy management and scheduling system 102, or a computing device that executes one or more compliance policies of the policy execution plan.

In some embodiments, compliance policy management and scheduling system 102 can provide technical improvements to a processing unit (e.g., processor 106) associated with a classical computing device and/or a quantum computing device (e.g., a quantum processor, quantum hardware, superconducting circuit, etc.). For example, by reducing latency of the computing devices that execute the at least two compliance policies as described above, compliance policy management and scheduling system 102 can thereby facilitate improved performance and/or efficiency of a processing unit (e.g., processor 106) associated with such computing devices. In another example, by generating such an updated directed acyclic graph and/or such a policy execution plan based on the updated directed acyclic graph as described above, compliance policy management and scheduling system 102 can facilitate reduced processing cycles performed by a processing unit (e.g., processor 106) to accurately execute the compliance policies of such a policy execution plan. For instance, compliance policy management and scheduling system 102 can facilitate reduced processing cycles performed by a processing unit (e.g., processor 106) associated with compliance policy management and scheduling system 102 and/or a computing device that executes one or more compliance policies of the policy execution plan, thereby facilitating at least one of improved accuracy, efficiency, or performance of such a processing unit (e.g., processor 106), as well as reduced computation cost of such a processing unit.

In some embodiments, compliance policy management and scheduling system 102 can employ hardware or software to solve problems that are highly technical in nature, that are not abstract and. that cannot be performed as a set of mental acts by a human. In some embodiments, some of the processes described herein can be performed by one or more specialized computers (e.g., one or more specialized processing units, a specialized quantum computer, etc.) for carrying out defined tasks related to the various technologies identified above. In some embodiments, compliance policy management and scheduling system 102 and/or components thereof, can be employed to solve new problems that arise through advancements in technologies mentioned above, employment of quantum computing systems, cloud computing systems, computer architecture, and/or another technology.

It is to be appreciated that compliance policy management and scheduling system 102 can utilize various combinations of electrical components, mechanical components, and circuitry that cannot be replicated in the mind of a human or performed by a human, as the various operations that can be executed by compliance policy management and scheduling system 102 and/or components thereof as described herein are operations that are greater than the capability of a human mind. For instance, the amount of data processed, the speed of processing such data, or the types of data processed by compliance policy management and scheduling system 102 over a certain period of time can be greater, faster, or different than the amount, speed, or data type that can be processed by a human mind over the same period of time.

According to several embodiments, compliance policy management and scheduling system 102 can also be fully operational towards performing one or more other functions (e.g., fully powered on, fully executed, etc.) While also performing the various operations described herein. It should be appreciated that such simultaneous multi-operational execution is beyond the capability of a human mind. It should also be appreciated that compliance policy management and scheduling system 102 can include information that is impossible to obtain manually by an entity, such as a human user. For example, the type, amount, or variety of information included in compliance policy management and scheduling system 102, policy analyzer component 108, scheduler component 110, trainer component 202, and/or policy correlation ML model 302 can be more complex than information obtained manually by a human user.

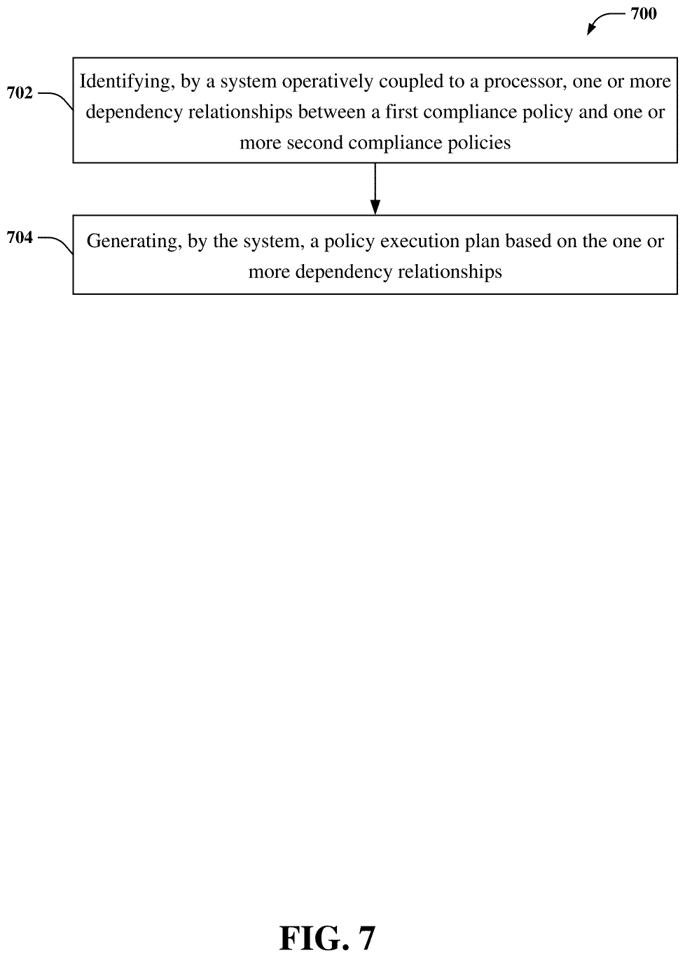

FIG. 7 illustrates a flow diagram of an example, non-limiting computer-implemented method 700 that can facilitate computational creativity in accordance with one or more embodiments described herein. Repetitive description of like elements and/or processes employed in respective embodiments is omitted for sake of brevity.

In some embodiments, at 702, computer-implemented method 700 can comprise identifying, by a system (e.g., via compliance policy management and scheduling system 102 and/or policy analyzer component 108) operatively coupled to a processor (e.g., processor 106), one or more dependency relationships (e.g., correlations) between a first compliance policy (e.g., a newly received compliance policy of a certain domain) and one or more second compliance policies (e.g., existing compliance policies of a certain domain).

In some embodiments, at 704, computer-implemented method 700 can comprise generating, by the system (e.g., via compliance policy management and scheduling system 102 and/or scheduler component 110), a policy execution plan (e.g., a parallel policy execution plan) based on the one or more dependency relationships.

For simplicity of explanation, the computer-implemented methodologies are depicted and described as a series of acts, It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 8 as well as the following discussion are intended to provide a general description of a suitable environment in which the various aspects of the disclosed subject matter can be implemented. Fla 8 illustrates a block diagram of an example, non-limiting operating environment in which one or more embodiments described herein can be facilitated. Repetitive description of like elements employed in other embodiments described herein is omitted for sake of brevity.

With reference to FIG. 8, a suitable operating environment 800 for implementing various aspects of this disclosure can also include a computer 812, The computer 812 can also include a processing unit 814, a system memory 816, and a system bus 818. The system bus 818 couples system components including, but not limited to, the system memory 816 to the processing unit 814. The processing unit 814 can be any of various available processors, Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 816 can also include volatile memory 820 and nonvolatile memory 822. The basic input/output system (BIOS), containing the basic routines to transfer information between elements within the computer 812, such as during start-up, is stored in nonvolatile memory 822, Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media. To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828, Operating system 828, which can be stored on disk storage 824, acts to control and allocate resources of the computer 812.

System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc, LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812, The hardware/software for connection to the network interface 848 can also include, for exemplary purposes only, internal and external technologies such as, modems including regular telephone grade modems, cable modems and DSL modems, ISDN adapters, and Ethernet cards.

Referring now to FIG. 9, an illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device, It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066, In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Non-limiting examples of workloads and functions which may be provided from this layer include: mapping and navigation 1091; software development and lifecycle management 1092; virtual classroom education delivery 1093; data analytics processing 1094; transaction processing 1095; and compliance policy management and scheduling software 1096.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process anchor thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” “data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a policy analyzer component that identifies one or more dependency relationships between a first compliance policy and one or more second compliance policies; and
a scheduler component that generates a policy execution plan based on the one or more dependency relationships.

2. The system of claim 1, wherein the computer executable components further comprise:
a trainer component that trains a model to identify at least one of the one or more dependency relationships or a direction of the one or more dependency relationships based on at least one of dependency data corresponding to historical compliance policies, expert feedback, or operational data feedback.

3. The system of claim 1, wherein the policy analyzer component identifies a direction of the one or more dependency relationships.

4. The system of claim 1, wherein the policy analyzer component identifies the one or more dependency relationships based on one or more similarities between the first compliance policy and one or more historical compliance policies, and. wherein the one or more similarities are selected from a group consisting of compliance policy description similarity, compliance policy code similarity, and compliance policy weakness similarity.

5. The system of claim 1, wherein the policy analyzer component identifies the one or more dependency relationships based on at least one of expert feedback or operational data feedback.

6. The system of claim 1, wherein the policy execution plan comprises a parallel policy execution plan to execute at least two compliance policies simultaneously based on the one or more dependency relationships.

7. The system of claim 1, wherein the scheduler component:
generates an updated directed acyclic graph based on at least one of expert feedback, operational data feedback, or the one or more dependency relationships; and
employs the updated directed acyclic graph to generate the policy execution plan, thereby facilitating at least one of improved accuracy, efficiency, or performance of at least one of the scheduler component, the processor, or a computing device that executes one or more compliance policies of the policy execution plan.

8. A computer-implemented method, comprising:
identifying, by a system operatively coupled to a processor, one or more dependency relationships between a first compliance policy and one or more second compliance policies; and
generating, by the system, a policy execution plan based on the one or more dependency relationships.

9. The computer-implemented method of claim 8, further comprising:
training, by the system, a model to identify at least one of the one or more dependency relationships or a direction of the one or more dependency relationships based on at least one of dependency data corresponding to historical compliance policies, expert feedback, or operational data feedback.

10. The computer-implemented method of claim 8, further comprising:
identifying, by the system, a direction of the one or more dependency relationships.

11. The computer-implemented method of claim 8, further comprising:
identifying, by the system, the one or more dependency relationships based on one or more similarities between the first compliance policy and one or more historical compliance policies, wherein the one or more similarities are selected from a group consisting of compliance policy description similarity, compliance policy code similarity, and compliance policy weakness similarity.

12. The computer-implemented method of claim 8, farther comprising:
identifying, by the system, the one or more dependency relationships based on at least one of expert feedback or operational data feedback.

13. The computer-implemented method of claim 8, wherein the generating comprises:
generating, by the system, a parallel policy execution plan to execute at least two compliance policies simultaneously based on the one or more dependency relationships, thereby facilitating reduced latency of a computing device that executes one of the at least two compliance policies.

14. The computer-implemented method of claim 8, further comprising:
generating, by the system, an updated directed acyclic graph based on at least one of expert feedback, operational data feedback, or the one or more dependency relationships; and
employing, by the system, the updated directed acyclic, graph to generate the policy execution plan.

15. A computer program product facilitating compliance policy management and scheduling, the computer program product comprising a computer readable storage medium having program instructions embodied therewith, the program instructions executable by a processor to cause the processor to:
identify, by the processor, one or more dependency relationships between a first compliance policy and one or more second compliance policies; and
generate, by the processor, a policy execution plan based on the one or more dependency relationships.

16. The computer program product of claim 15, wherein the program instructions are further executable by the processor to cause the processor to:
train, by the processor, a model to identify at least one of the one or more dependency relationships or a direction of the one or more dependency relationships based on at least one of dependency data corresponding to historical compliance policies, expert feedback, or operational data feedback.

17. The computer program product of claim 15, wherein the program instructions are further executable by the processor to cause the processor to:
identify, by the processor, the one or more dependency relationships based on one or more similarities between the first compliance policy and one or more historical compliance policies, and wherein the one or more similarities are selected from a group consisting of compliance policy description similarity, compliance policy code similarity, and compliance policy weakness similarity.

18. The computer program product of claim 15, wherein the program instructions are further executable by the processor to cause the processor to:
identify, by the processor, a direction of the one or more dependency relationships; and
identify, by the processor, one or more dependency relationships based on at least one of expert feedback or operational data feedback.

19. The computer program product of claim 15, wherein the program instructions are further executable by the processor to cause the processor to:
generate, by the processor, a parallel policy execution plan to execute at least two compliance policies simultaneously based on the one or more dependency relationships.

20. The computer program product of claim 15, wherein the program instructions are further executable by the processor to cause the processor to:
generate, by the processor, an updated directed acyclic graph based on at least one of expert feedback, operational data feedback, or the one or more dependency relationships; and
employ, by the processor, the updated directed acyclic graph to generate the policy execution plan.
